(19) United States
(12) Patent Application Publication
(10) Pub. No.: US 2014/0347439 A1
(43) Pub. Date: Nov. 27, 2014

(54) MOBILE DEVICE AND SYSTEM FOR GENERATING PANORAMIC VIDEO

(71) Applicant: NVIDIA Corporation, Santa Clara, CA (US)

(72) Inventors: Zhen Jia, Shenzhen (CN); Lili Huang, Shenzhen (CN)

(73) Assignee: NVIDIA Corporation, Santa Clara, CA (US)

(21) Appl. No.: 13/974,229

(22) Filed: Aug. 23, 2013

(30) Foreign Application Priority Data
May 22, 2013 (CN) 201310193080.2

(51) Int. Cl. H04N 5/232

(52) U.S. Cl. CPC H04N 5/23238
USPC 348/36

(57) ABSTRACT

A system and mobile device for generating a panoramic video is presented. The system comprises a plurality of cameras and a mobile device. The mobile device further comprises a CPU and a GPU. The plurality of cameras is operable to capture video frames from different directions through 360° to generate multi-channel video streams. The CPU is configured to issue to the GPU an instruction to process the multi-channel video streams. The GPU is configured to mosaic synchronous video frames of the multi-channel video streams by utilizing parallel computing according to the instruction, so as to generate the panoramic video in real time.

### TECHNICAL FIELD

This application claims priority to Chinese Patent Application No. 201310193080.2 filed on May 22, 2013, which is hereby incorporated by reference in its entirety

### TECHNICAL FIELD

This application is directed, in general, to mobile devices, and more particularly to a mobile device and system for generating a panoramic video.

### BACKGROUND

With the development of science and technology and the progress of society, both the demands for and the requirements for information are increasing. More than 80% of information from the outside world gained by people comes from the vision, while images or videos are main ways for people to gain visual information. Panoramic imaging technology is technology which can present full 360° scene information so that viewers are not limited by the observation of scenes with a fixed angle of view. A panoramic image displays separate image information on an image completely. Representation schemes of panoramic image mainly include cylindrical panorama, cube panorama and sphere panorama. A panoramic video includes a sequence of panoramic images captured at different times. The panoramic video carries very rich amount of information and may display changing scenes in real time.

Now most of mobile devices in the market have only one or two cameras. In order to obtain a panoramic image, it is needed for users to take several images from different angles using a camera of their mobile devices while handling their mobile devices in hand and rotating their own bodies horizontally, and then to stitch these images together to composite a panoramic image by utilizing software. In general, the process of compositing a panoramic image is carried out in a Central Processing Unit (CPU) of a mobile device. The rotation of a mobile device causes the images to be taken asynchronously. In particular, when there is a moving object in the scene, it would be caused that software cannot composite a panoramic image correctly. In addition, software needs to mosaic several images when it composites a panoramic image. Therefore, there is a requirement for the area of the overlapping portion of two adjacent images when taking images, which is difficult for users to control. The composition of a panoramic image requires a relatively large amount of computation, so it is time-consuming. The frame rate of a panoramic video is commonly 20-30 fps. To achieve a rate at which a panoramic video is generated in real time, the amount of computation per second thereof would be tens of times that of a panoramic image, which is a huge challenge for both the processing capability of hardware systems and the work efficiency of software systems. Therefore, it is almost impossible to generate a panoramic video based on current hardware systems and software systems of mobile devices for generating a panoramic image.

### SUMMARY

One aspect provides, in one embodiment, a system for generating a panoramic video is disclosed. The system comprises a plurality of cameras and a mobile device. The mobile device further comprises a CPU and a graphics processing unit (GPU). The plurality of cameras is operable to capture video frames from different directions through 360° to generate multi-channel video streams. The CPU is configured to issue to the GPU an instruction to process the multi-channel video streams. The GPU is configured to mosaic synchronous video frames of the multi-channel video streams by utilizing parallel computing according to the instruction, so as to generate the panoramic video in real time.

Another aspect provides, in another embodiment, a mobile device for generating a panoramic video is presented. The mobile device comprises a CPU, a GPU and a USB interface. The USB interface is used to receive multi-channel video streams from a plurality of cameras. The CPU is configured to issue to the GPU an instruction to process the multi-channel video streams. The GPU is configured to mosaic synchronous video frames of the multi-channel video streams by utilizing parallel computing according to the instruction, so as to generate the panoramic video in real time.

### BRIEF DESCRIPTION OF THE DRAWINGS

Reference is now made to the following descriptions taken in conjunction with the accompanying drawings, in which:

FIG. 1 illustrates a schematic block diagram of a system for generating a panoramic video, according to an embodiment;

FIG. 2A illustrates a schematic top view of a system including 8 cameras each with an angle of view of 60°, according to an embodiment;

FIG. 2B illustrates a schematic top view of a system including 6 cameras each with an angle of view of 65°, according to another embodiment;

FIG. 3A illustrates a schematic diagram of a system in which a plurality of cameras are integrated in a mobile device, according to an embodiment; and

FIG. 3B illustrates a schematic diagram of a system in which a plurality of cameras are integrated in an individual video recording module, according to an embodiment.

### DETAILED DESCRIPTION

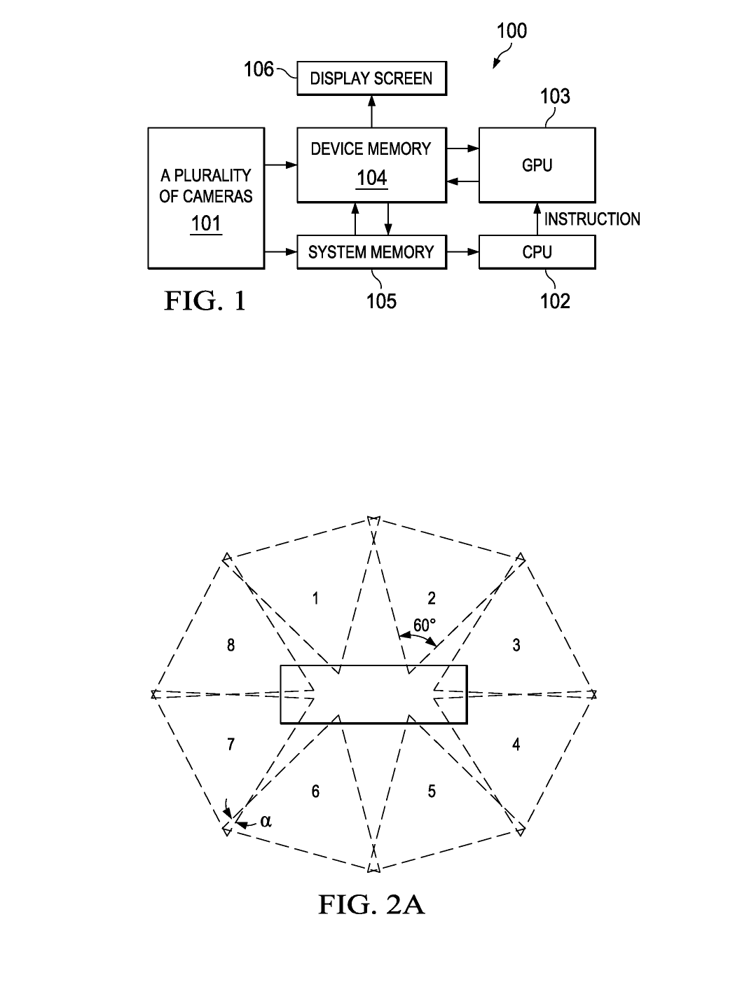

A system for generating a panoramic video is disclosed. FIG. 1 illustrates a schematic block diagram of a system 100 for generating a panoramic video, according to an embodiment of the present disclosure. The system 100 includes a plurality of cameras 101 and a mobile device. The mobile device further includes a CPU 102 and a GPU 103. For example, the mobile device may include a Tegra processor, in which the CPU 102 and the GPU 103 are integrated. The capability of the GPU 103 in aspects of floating point arithmetic and parallel arithmetic is actually much higher than that of the CPU 102. The GPU 103 may process a large number of computing data in parallel. The plurality of cameras 101 may be operable to capture video frames from different directions through 360° to generate multi-channel video streams. The CPU 102 may be configured to issue to the GPU 103 an instruction to process the multi-channel video streams. The GPU 103 may be configured to mosaic synchronous video frames of the multi-channel video streams by utilizing parallel computing according to the instruction, so as to generate the panoramic video in real time. Embodiments of the present disclosure utilize the powerful parallel computing ability of the GPU 103 to mosaic synchronous video frames faster in order to generate a panoramic video, which may have a high definition.

In one embodiment, video frames are captured from different directions covering a full 360° view through the plurality of cameras 101, and a panoramic image of surroundings at a time may be generated. The way of using a plurality of cameras enables users to obtain video frames needed for a panoramic video without rotating the mobile device and the obtained video frames are synchronized. This way may clearly present a moving object within a panoramic video. Position relations among each of the plurality of cameras 101 are fixed, and thus users don't need to control the area of overlapping part of the taken scenes and are provided convenience. Each camera may include camera lens, an image sensor and a digital signal processor (DSP), etc. An optical image of a scene generated through the camera lens is projected on a surface of the image sensor. The image sensor converts the optical image into digital image signals after analog to digital (A/D) conversion. Then the digital image signals are transmitted to the DSP for processing and then output as video frames. Consecutive video frames form a video stream. The camera lens may include optical lens, a lens barrel, a spacer ring, etc. The camera lens may employ glass lens, plastic lens or plastic glass lens. The image sensor may be a CMOS sensor or a charge coupled device (CCD) sensor. The CCD sensor has high sensitivity, small noise and large signal-to-noise ratio. The CMOS sensor has high integration, low power consumption and low cost.

Alternatively, the system 100 may also include one or more flashlights for increasing exposure in low light condition.

In an embodiment, any two adjacent cameras of the plurality of cameras 101 have their respective fields of view overlapped with each other in an overlapping portion, and the overlapping portion has an angle α of 3° to 5° in the plane in which the optical axes of the two adjacent cameras are located. Image matching may be performed by utilizing an overlapping portion of video frames from two adjacent scenes during mosaicing synchronous video frames, thus it is beneficial for subsequent effective mosaic of synchronous video frames that there is an appropriate overlapping portion between fields of view of any two adjacent cameras of the plurality of cameras 101. Too large overlapping portion would increase the amount of computation and too small overlapping portion may cause inaccurate image matching. The overlapping portion with an angle of 3°-5° may satisfy the demand of image matching and also ensure reasonable use of hardware and software resources.

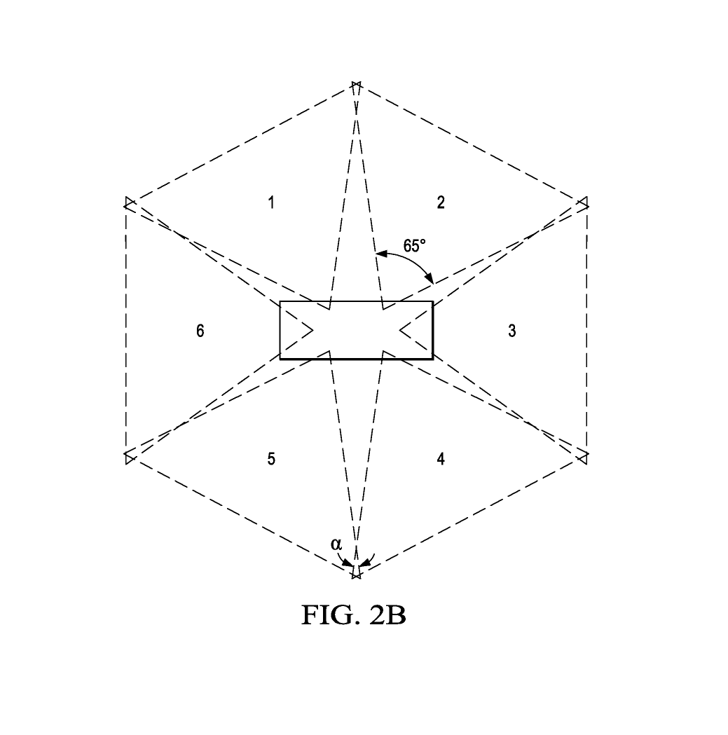

In an embodiment, the angle of view of each of the plurality of cameras 101 is not less than 60°. Because the total angle of view of the plurality of cameras 101 needs to cover a full 360° view, therefore, the minimum number of cameras is limited by the angle of view of each of the plurality of cameras 101. The minimum number of cameras may be calculated in a situation where the angle of view of each camera is determined. In an embodiment, all cameras of the plurality of cameras 101 have the same angle of view, which is beneficial for design and installation of the plurality of cameras 101 and subsequent mosaic of video frames. In one embodiment, the number of cameras is 8 and the angle of view of each camera is 60°. FIG. 2A illustrates a schematic top view of a system including 8 cameras each with an angle of view of 60°, according to an embodiment of the present disclosure. In FIG. 2A, respective fields of view of 8 cameras 1, 2 . . . 8 and the angle α of the overlapping portion between the field of view 6 and the field of view 7. In another embodiment, the number of cameras is 6 and the angle of view of each camera is 65°. FIG. 2B illustrates a schematic top view of a system including 6 cameras each with an angle of view of 65°, according to another embodiment of the present disclosure. In FIG. 2B, respective fields of view of 6 cameras 1, 2 . . . 6 and the angle α of the overlapping portion between the field of view 4 and the field of view 5. When the angle of view of each camera increases, the number of cameras may decrease accordingly.

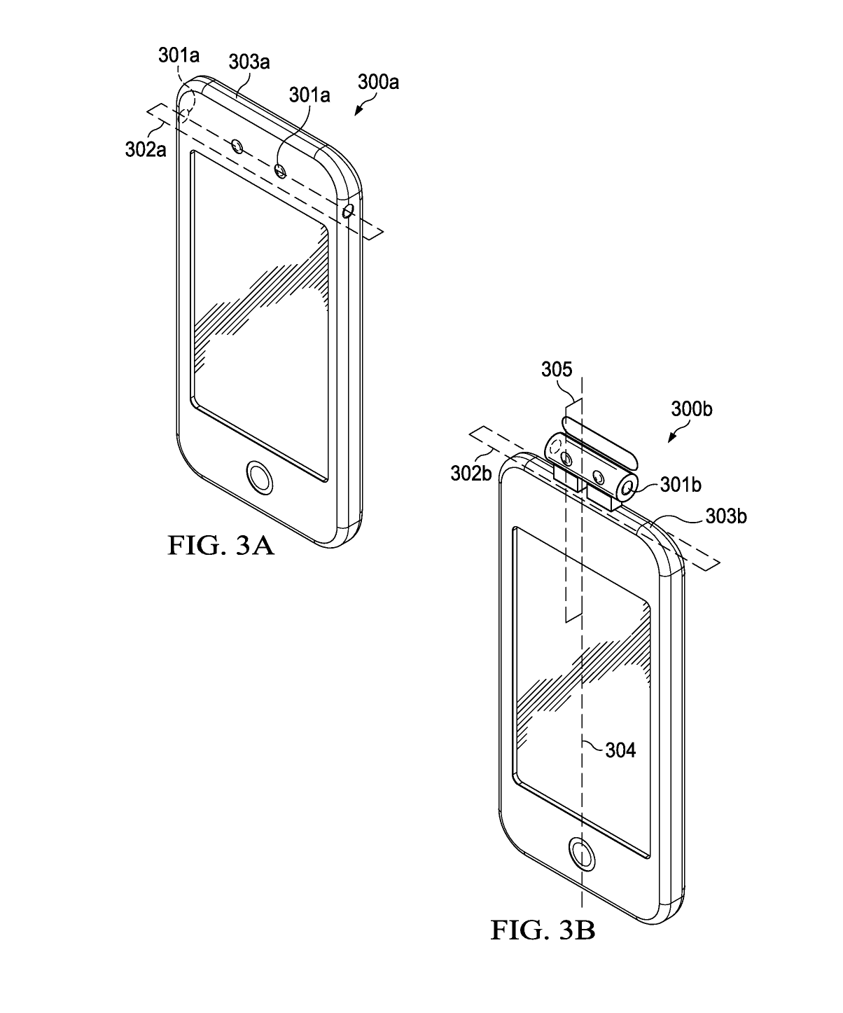

In one embodiment, the plurality of cameras 101 is integrated in the mobile device. Each of the plurality of cameras 101 includes a CMOS sensor interface (CSI) for transferring a corresponding video stream of the multi-channel video streams to the GPU 103. The CSI is included in Mobile Industry Processor Interface (MIPI) and restricted by MIPI protocol. CSI is suitable for the mobile device. FIG. 3A illustrates a schematic diagram of a system 300a in which a plurality of cameras 301a are integrated in a mobile device, according to an embodiment of the present disclosure. Integration of a plurality of cameras into a mobile device is beneficial and convenient for users to use.

In an embodiment, the plurality of cameras 301a are arranged on the same plane 302a parallel to a top surface 303a of the mobile device. The top surface 303a of the mobile device refers to a surface of the mobile device which is on the top when the mobile device is normally used in a vertical state. For example, when the top surface 303a of the mobile device is parallel to the ground, the plurality of cameras 301a may keep various optical axes on the same horizontal plane, thus the taken scenes are located at the same height.

In another embodiment, the plurality of cameras is integrated in an individual video recording module. The video recording module may further include a USB interface for being connected to a USB interface of the mobile device. FIG. 3B illustrates a schematic diagram of a system 300b in which a plurality of cameras 301b are integrated in an individual video recording module, according to another embodiment of the present disclosure. Integration of a plurality of cameras into an individual video recording module is beneficial for reducing the weight of the mobile device, thus it is more convenient for users to carry it with them. A USB interface is employed so that hot plug of the video recording module can be realized. The USB interface of the video recording module matches the USB interface of the mobile device and may employ USB 2.0 interface or USB 3.0 interface. Alternatively, the USB interface of the video recording module is male interface and the USB interface of the mobile device is female interface.

The resolutions (pixels) of and the refresh rates (frame rates) of the plurality of cameras 301b may be determined based on the bandwidth of the USB interface of the video recording module. For a particular USB interface, its bandwidth (transmission rate) may be determined. All cameras may have the same resolution and the same refresh rate, which is beneficial for design and data processing. The product of the resolution and the refresh rate may be proportional to the bandwidth of the USB interface, thus the bandwidth may be fully utilized.

In one embodiment, the plurality of cameras 301b are arranged on the same plane 302b parallel to a top surface 303b of the mobile device when the video recording module is connected to the mobile device. For example, when the video recording module is connected with the mobile device and the mobile device is normally used in a vertical state, the plurality of cameras 301b may keep various optical axes on the same horizontal plane, thus the taken scenes are located at the same height.

In one embodiment, the plurality of cameras 301b is fixed in the video recording module. In another embodiment, each of the plurality of cameras 301b is rotatable so that the optical axis thereof is adjustable within a plane defined by the optical axis and a perpendicular bisector of the mobile device when the video recording module is connected to the mobile device. A straight line which is along the direction of the gravity of the mobile device when the top surface 303b of the mobile device is parallel to the ground is defined as the perpendicular bisector of the mobile device. In FIG. 3B, a perpendicular bisector 304 and a plane 305 defined by the perpendicular bisector 304 and the optical axis of a certain camera are shown. The direction of the optical axis of that camera is adjustable within the plane 305. Because the direction of the optical axis of the camera is adjustable, the camera may shoot richer scenes without being limited by a certain plane. Alternatively, the plurality of cameras 301b is rotatable synchronously. The plurality of cameras 301b being rotatable synchronously enables the adjustment to be more convenient and is beneficial for keeping directions of all optical axes within a plane or an approximate cone. Because the position relations among each of the plurality of cameras are fixed, subsequent processing may be simpler. For example, when users desire to shoot a scene below from above, which is similar to the shooting way of a monitoring device, users may adjust the plurality of cameras 301b within their respective planes in which their optical axes are adjustable. Because the plurality of cameras 301b is rotatable synchronously, rotating the optical axis of a camera downward enables optical axes of all other cameras to be equally rotated downward. Therefore, users may conveniently change a shooting angle of a camera as needed and obtain different scene images.

Referring back to FIG. 1, the CPU 102 may communicate with the GPU 103. The CPU 102 controls the GPU 103 to process various tasks by sending instructions to the GPU 103. In embodiments of the present disclosure, the GPU 103 mosaics synchronous video frames of the multi-channel video streams from the plurality of cameras 101 after receiving an instruction from the CPU 102. The process of mosaicing synchronous video frames may include image pre-processing, image matching, image re-projection and image fusion, etc.

Patterned earlier stage processing, such as modifying the color mode of video frames, modifying the size of video frames, filtering, distortion correction, etc., is performed on video frames by using image pre-processing, so as to provide images which may satisfy subsequent processing requirements and easy to be processed. Image matching is a process of aligning in space two or more video frames captured from different directions by different cameras according to video frame data or a camera model. For example, image matching may be performed according to an overlapping portion of two adjacent video frames. The GPU 103 may perform image matching by using a feature-based matching algorithm or a region-based matching algorithm. In an embodiment, the GPU 103 performs image matching by using a region-based matching algorithm. The region-based matching algorithm has less logical judgment and branch processing and includes a large number of highly parallel repetitive computing, thus it is beneficial for being realized on GPU and may get better acceleration performance. The region-based matching algorithm includes establishing a similarity relation between two images by utilizing information about the entire image, and then finding parameter values of a transformation model with maximum similarity measure value or minimum similarity measure value by using a certain searching method. For example, a matching window (or matching template) is created by using a point to be matched P in an image to be matched M as a central pixel. The gray information of the image within the matching window is used to represent features of the pixel, while a neighborhood of pixel which has the same size as the matching window is extracted from a search region S of a matching image N. The level of similarity between the two windows is calculated according to similarity measure criteria. Image re-projection is a process of solving a transformation model of the matched video frames and projecting all synchronous video frames into the same coordinate system by utilizing a matching parameter or matching parameters to composite an image. Image fusion is a process of smoothing the composited image and eliminating a matching error and a seam-line existing in the overlapping region during image composition to improve visual effects of the composited image. Because there is a great number of parallel computing during mosaicing synchronous video frames and GPU has powerful parallel computing ability, thus GPU is very suitable for mosaicing synchronous video frames. GPU may process video frames faster than CPU and may satisfy requirements for generating a panoramic video in time.

In one embodiment, the GPU 103 is based on single instruction multiple data (SIMD) regime. The GPU 103 includes multiple stream processors for executing the task of mosaicing synchronous video frames in parallel. In an embodiment, the GPU 103 may be configured to mosaic the synchronous video frames based on CUDA. In CUDA programming environment, the CPU 102 is used as a host and the GPU 103 is used as a device. The CPU 102 is responsible for executing high logical transaction processing and serial computing, and application for video memory, data access and thread creation on the GPU 103. The GPU 103 is specific for executing highly threaded parallel computing. In embodiments of the present disclosure, the task of mosaicing synchronous video frames, which may include image pre-processing, image matching, image re-projection and image fusion, etc., is organized into a large number of parallel threads for being executed in stream processors. CUDA employs a unified processing architecture, so that programming difficulty may be reduced and the parallel computing ability of the GPU may be simply utilized to execute intensive computing.

Alternatively, the mobile device may further include a device memory 104 for buffering the multi-channel video streams to be processed by the GPU 103 and the panoramic video generated by the GPU 103. The device memory 104 may be an individual memory or a memory residing within a system memory of the mobile device. In one embodiment, the plurality of cameras 101 directly transmits the multi-channel video streams to the device memory 104 via a data bus in the mobile device. Then the GPU 103 may read the multi-channel video streams stored in the device memory 104 for processing. Using the device memory 104 to buffer the multi-channel video streams is beneficial for synchronizing the transmission rate of the plurality of cameras 101 and the processing speed of the GPU 103. After the GPU 103 generates a panoramic video by utilizing the multi-channel video streams, the generated panoramic video may be stored in the device memory 104.

In an embodiment, the mobile device may further include a system memory 105. In one embodiment, the multi-channel video streams are transmitted to the system memory 105 by the plurality of cameras 101 via a data bus in the mobile device, and then are transmitted to the device memory 104. Furthermore, the panoramic video stored in the device memory 104, which is generated by the GPU 103, may be transmitted to the system memory 105. The CPU 102 may read the panoramic video stored in the system memory 105 for further processing.

In an embodiment, the mobile device may further include a display screen 106 for displaying the panoramic video at least in part. The panoramic video stored in the device memory 104 may be output onto the display screen 106 via a display interface for displaying.

In an embodiment, each frame of a panoramic video is editable. Frames of a panoramic video may be edited by the GPU 103 in real time during the generation of the panoramic video. Also, the panoramic video stored in the system memory 105 may be edited by the CPU 102. Similarly, a control instruction from users may be responded to in real time during capturing video frames or after processing video frames.

In an embodiment, the GPU 103 may be further configured to adjust the content of the panoramic video displayed on the display screen 106 according to a user instruction. The mobile device may receive an instruction to adjust the content of the panoramic video from users through the display screen or a keypad. The GPU 103 may adjust the display content according to the instruction input by users, such as adjusting brightness, contrast, tones of the video, etc., or changing the size, the viewing angle of the panoramic video, etc. The panoramic video includes scene information from directions through 360°, and users may freely select the part of the panoramic video which they are eager to see as needed.

Alternatively, the GPU 103 may be further configured to perform object tracking on the panoramic video according to a user instruction. The display screen 106 may be further operable to display the tracked object. The mobile device may receive an instruction to track an object from users through the display screen or a keypad. The GPU 103 may first detect the object to be tracked, i.e., target object. Detecting is a process of extracting a region of interest (a target object region) from the background image in a sequence of video frames of the panoramic video to form a target template. Then the GPU 103 finds the location of an image most similar to the target object in the sequence of video frames to track the object. The GPU 103 may use an object tracking method which is based on feature points, an object template or movement information to track the object.

Alternatively, the GPU 103 may be further configured to perform image stabilization computing on the panoramic video. Image stabilization computing may include image pre-processing, interframe motion estimation, motion compensation, etc. The GPU 103 may first perform image pre-processing on video frames of the panoramic video, including, for example, utilizing median filtering and/or elimination of Gaussian noise to eliminate random dot-noise, while normalizing the image, for example, transforming color space to eliminate the influence of light. Interframe motion estimation algorithm may include block matching algorithm, representative point comparison method, edge detection matching algorithm, bit-plane matching algorithm, projection algorithm, etc. In an embodiment, a block matching algorithm is employed. The block matching algorithm divides each video frame into multiple non-overlapping macroblocks, and considers that all pixels in a macroblock have the same displacement. For each microblock, i.e., current block, a most similar block, i.e., matching block is found within a certain given search scope in a reference video frame according to a particular matching criterion. A relative displacement between the matching block and the current block is a motion vector. Motion compensation is a process of compensating the current frame by utilizing a previous frame based on the motion vector. Because the panoramic video includes scene information from directions through 360°, there would not be a shadow in the edge section while compensating the current frame by utilizing the previous frame.

In an embodiment, the GPU 103 performs the above described adjusting of the display content, object tracking and image stabilization computing based on CUDA.

In another aspect of the present disclosure, a mobile device for generating a panoramic video is also disclosed. The mobile device may include a CPU, a GPU and a USB interface. The USB interface may be used to receive multi-channel video streams from a plurality of cameras. The CPU may be configured to issue to the GPU an instruction to process the multi-channel video streams. The GPU may be configured to mosaic synchronous video frames of the multi-channel video streams by utilizing parallel computing according to the instruction, so as to generate the panoramic video in real time.

Alternatively, the USB interface of the mobile device matches a USB interface of a video recording module in which the plurality of cameras are located. The USB interface of the mobile device may be female interface. The USB interface of the mobile device may be USB 2.0 interface or USB 3.0 interface.

Alternatively, the mobile device may further include a device memory for buffering the multi-channel video streams to be processed by the GPU and the panoramic video generated by the GPU.

Alternatively, the mobile device may further include a display screen for displaying the panoramic video at least in part.

The USB interface, the CPU, the GPU, the device memory and the display screen involved in the above mobile device for generating a panoramic video have been described in the description about embodiments of the system for generating a panoramic video. For brevity, a detailed description thereof is omitted. Those skilled in the art can understand that specific structure and operation mode thereof with reference to FIG. 1 and FIG. 3B in combination with the above description.

The GPU can further be configured to mosaic the synchronous video frames based on Compute Unified Device Architecture (CUDA). The plurality of cameras can be integrated in the mobile device. Each of the plurality of cameras can include a complementary metal oxide semiconductor (CMOS) sensor interface for transferring a corresponding video stream of the multi-channel video streams to the GPU. The plurality of cameras can be arranged on the same plane parallel to a top surface of the mobile device. The plurality of cameras can be integrated in an individual video recording module. The video recording module further includes a universal serial bus (USB) interface for being connected to a USB interface of the mobile device.

The resolutions of and the refresh rates of the plurality of cameras can be determined based on the bandwidth of the USB interface of the video recording module. The plurality of cameras can be arranged on the same plane parallel to a top surface of the mobile device when the video recording module is connected to the mobile device. Each of the plurality of cameras can be rotatable so that the optical axis thereof is adjustable within a plane defined by the optical axis and a perpendicular bisector of the mobile device when the video recording module is connected to the mobile device.

The plurality of cameras can be rotatable synchronously. Any two adjacent cameras of the plurality of cameras can have their respective fields of view overlapped with each other in an overlapping portion, and the overlapping portion has an angle α of 3° to 5° in the plane in which the optical axes of the two adjacent cameras are located. The angle of view of each of the plurality of cameras may not be less than 60°. The mobile device may further include a device memory for buffering the multi-channel video streams to be processed by the GPU and the panoramic video generated by the GPU.

The mobile device may further include a display screen for displaying the panoramic video at least in part. The GPU can further be configured to adjust the content of the panoramic video displayed on the display screen according to a user instruction. The GPU can further be configured to perform object tracking on the panoramic video according to a user instruction. The display screen is further operable to display the tracked object. The GPU can further be configured to perform image stabilization computing on the panoramic video.

The GPU can further be configured to mosaic the synchronous video frames based on CUDA. The mobile device can further include a device memory for buffering the multi-channel video streams to be processed by the GPU and the panoramic video generated by the GPU. The mobile device can further include a display screen for displaying the panoramic video at least in part.

Those skilled in the art to which this application relates will appreciate that other and further additions, deletions, substitutions and modifications may be made to the described embodiments.

What is claimed is:

1. A system for generating a panoramic video, including a plurality of cameras and a mobile device, the mobile device further including a central processing unit and a graphics processing unit,
wherein the plurality of cameras are operable to capture video frames from different directions through 360° to generate multi-channel video streams;
wherein the central processing unit is configured to issue to the graphics processing unit an instruction to process the multi-channel video streams; and
wherein the graphics processing unit is configured to mosaic synchronous video frames of the multi-channel video streams by utilizing parallel computing according to the instruction, so as to generate the panoramic video in real time.

2. The system according to claim 1, wherein the graphics processing unit is further configured to mosaic the synchronous video frames based on Compute Unified Device Architecture.

3. The system according to claim 1, wherein the plurality of cameras are integrated in the mobile device, wherein each of the plurality of cameras includes a CMOS sensor interface for transferring a corresponding video stream of the multi-channel video streams to the graphics processing unit.

4. The system according to claim 3, wherein the plurality of cameras are arranged on the same plane parallel to a top surface of the mobile device.

5. The system according to claim 1, wherein the plurality of cameras are integrated in an individual video recording module, and the video recording module further includes a USB interface for being connected to a USB interface of the mobile device.

6. The system according to claim 5, wherein the resolutions of and the refresh rates of the plurality of cameras are determined based on the bandwidth of the USB interface of the video recording module.

7. The system according to claim 5, wherein the plurality of cameras are arranged on the same plane parallel to a top surface of the mobile device when the video recording module is connected to the mobile device.

8. The system according to claim 7, wherein each of the plurality of cameras is rotatable so that the optical axis thereof is adjustable within a plane defined by the optical axis and a perpendicular bisector of the mobile device when the video recording module is connected to the mobile device.

9. The system according to claim 8, wherein the plurality of cameras are rotatable synchronously.

10. The system according to claim 1, wherein any two adjacent cameras of the plurality of cameras have their respective fields of view overlapped with each other in an overlapping portion, and the overlapping portion has an angle α of 3° to 5° in the plane in which the optical axes of the two adjacent cameras are located.

11. The system according to claim 1, wherein the angle of view of each of the plurality of cameras is not less than 60°.

12. The system according to claim 1, wherein the mobile device further includes a device memory for buffering the multi-channel video streams to be processed by the graphics processing unit and the panoramic video generated by the graphics processing unit.

13. The system according to claim 1, wherein the mobile device further includes a display screen for displaying the panoramic video at least in part.

14. The system according to claim 13, wherein the graphics processing unit is further configured to adjust the content of the panoramic video displayed on the display screen according to a user instruction.

15. The system according to claim 13, wherein the graphics processing unit is further configured to perform object tracking on the panoramic video according to a user instruction, wherein the display screen is further operable to display the tracked object.

16. The system according to claim 1, wherein the graphics processing unit is further configured to perform image stabilization computing on the panoramic video.

17. A mobile device for generating a panoramic video, including a central processing unit, a graphics processing unit and a USB interface,
wherein the USB interface is used to receive multi-channel video streams from a plurality of cameras;
wherein the central processing unit is configured to issue to the graphics processing unit an instruction to process the multi-channel video streams; and
wherein the graphics processing unit is configured to mosaic synchronous video frames of the multi-channel video streams by utilizing parallel computing according to the instruction, so as to generate the panoramic video in real time.

18. The mobile device according to claim 17, wherein the graphics processing unit is further configured to mosaic the synchronous video frames based on Compute Unified Device Architecture.

19. The mobile device according to claim 17, wherein the mobile device further includes a device memory for buffering the multi-channel video streams to be processed by the graphics processing unit and the panoramic video generated by the graphics processing unit.

20. The mobile device according to claim 17, wherein the mobile device further includes a display screen for displaying the panoramic video at least in part.
